(19) United States
(12) Patent Application Publication
(10) Pub. No.: US 2019/0143301 A1
(43) Pub. Date: May 16, 2019

(54) MATERIALS FOR REMOVING AIR POLLUTANTS

(71) Applicant: Honeywell International Inc., Morris Plains, NJ (US)

(72) Inventors: Kai Huang, Shanghai (CN); Marilyn Wang, Shanghai (CN); Xingping Wang, Songjiang District (CN); Wesley Nie, Shanghai (CN); Hailin Liu, Shanghai (CN)

(21) Appl. No.: 15/811,182

(22) Filed: Nov. 13, 2017

(51) Int. Cl. B01J 20/28; B01D 46/00; D06B 1/02; D06M 15/507; D06M 11/59; D06M 11/46

(52) U.S. Cl. CPC B01J 20/28028; B01D 46/0001; D06B 1/02; D06M 15/507; D06M 2101/28; D06M 11/46; B01D 2279/65; B01D 2257/708; D06M 11/59

(57) ABSTRACT

A non-woven article that contains a component that reacts with air pollutants in the air is described. The non-woven article can be formed into a fabric that can be used in a variety of household items.

### BACKGROUND

Rapid economic development in many countries has resulted in increased environmental pollution. In particular, indoor environmental pollution caused by the use of various chemicals associated with the production of items such as decorative materials, furniture, tobacco, and household appliances is of growing concern. Many of the appliances, furnishings, and painted surfaces found in new home constructions release volatile organic compounds (VOCs). VOCs include hydrocarbons, carbonyl compounds, organic acids, organic peroxides, organic sulfur compounds, organic halides, and the like. VOCs can also participate in photochemical reaction with nitrogen oxides and sulfides of the atmosphere upon exposure to light and form highly toxic photochemical smog.

Many VOCs have been found to be carcinogenic or suspected carcinogens (such as formaldehyde, benzene, tetrachlorethylene, trichloroethane, trichlorethylene, and the like). Major emission sources of indoor air VOCs include wall coatings (e.g., paint and wallpaper) and oil paints and varnishes for furniture. However, recently, houses have become more and more airtight and, accordingly, VOCs can result in more serious health issues because they cannot rapidly escape the indoor environment.

Products for removing formaldehyde are generally divided into two categories: (1) a variety of sprays that can be sprayed on the surface of furniture, walls and other sources of pollution; and (2) hydrogel products placed indoors.

### SUMMARY OF THE INVENTION

In various embodiments, an article for removing one or more air pollutants from air includes a non-woven material comprising at least one polymer, and at least one component reactive with at least one air pollutant.

In various embodiments, an article for removing one or more air pollutants from air includes a non-woven material including polyacrylonitrile, and about 1 to 10 wt % of titanium dioxide nanoparticles, wherein the non-woven material has a fiber areal weight (FAW) of about 30 to about 100 g/m².

Advantageously, various embodiments of the non-woven article of the present invention can be used as a fabric or incorporated into fabrics used in everyday household items, such as blankets, rugs, tablecloths, etc. Various embodiments of the non-woven article of the present invention can remove air pollutants from the air continuously while also acting functional household items. Advantageously, the high surface area of the fabric can facilitate the adsorption of VOCs.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “fiber areal weight” (FAW) is defined as A_{f}=2N_{f}N_{T}πr²_{fρf}, wherein N_{f} is the number of filaments per tow, N_{T} is the number of tows in a unit width of fabric, r_{f} is the radius of the fiber cross-section, and ρ_{f} is the density of the fibers.

### Non-Woven Article

In various embodiments, an article for removing one or more air pollutants from air includes a non-woven material comprising at least one polymer, and at least one component reactive with at least one air pollutant. In various embodiments, the at least one component is homogenously distributed throughout the non-woven material.

The at least one polymer can be chosen from aramid, polyimide, polycaprolactam, polyester, polyvinylchloride, nylon, polyvinylpyrrolidone, poly(methyl methacrylate), polyacrylonitrile, polypropylene, polyethylene, co-polymers thereof, and mixtures thereof. In various embodiments, the at least one polymer comprises polyacrylonitrile. The at least one polymer can be about 1 to 20 wt % of the article. The at least one polymer can be about 1 to 19 wt %, 1 to 18 wt %, 1 to 17 wt %, 1 to 16 wt %, 1 to 15 wt %, 1 to 10 wt %, 1 to 9 wt %, 1 to 8 wt %, 1 to 7 wt %, 1 to 6 wt %, 1 to 5 wt %, 1 to 4 wt %, 1 to 3 wt %, or 1 to 2 wt % of the article. The at least one polymer can be about 20 wt %, 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt % of the article, or any range or sub-range between any of these values.

In various embodiments, the air pollutant is a volatile organic compound (VOC) that can include formaldehyde, benzene, toluene, xylene, para-dichlorobenzene, ethyl benzene, styrene, acetaldehyde, cyclohexanone, isophorone, methanol, ethanol, phenol, acetone, ethyl acetate, n-butanol, methyl isobutyl ketone, n-butyl acetate, acetophenone, methyl ethyl ketone, isopropyl alcohol, dichloromethane, trichloroethylene, n-hexane, 2-methoxylethyl acetate, nitrobenzene, bis-(2-methyoxyethyl)ether, 1,3,5-trimethyibenzene, and mixtures thereof.

In various embodiments, the at least one component reacts with an aldehyde or ketone group in the at least one air pollutant. The reaction can be, for example, a nucleophilic reaction with the carbonyl group in the at least one air pollutant. The at least one air pollutant can be formaldehyde.

In various embodiments, the at least one component reactive with at least one air pollutant is taurine, a tea polyphenol, sodium polyacrylate, chitin, titanium dioxide nanoparticles, titanium dioxide microparticles, a tannin, a lignin, a flavonoid, a phenolic compound, carvacrol, eugenol, and mixtures thereof. In various embodiments, the reactive component is titanium dioxide nanoparticles or titanium dioxide microparticles. When nanoparticles are used, they have an average particle size, as measured by the largest particle dimension, of about 5 to about 100 nm. The nanoparticles can have an average particle size of 5 nm to 90 nm, 5 nm to 80 nm, 5 nm to 70 nm, 5 nm to 60 nm, 5 nm to 50 nm, 5 nm to 40 nm, 5 nm to 30 nm, 5 nm to 20 nm, 5 nm to 10 nm, or any range or sub-range between these values. The nanoparticles can have an average particle size of about 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, or any range or sub-range between these values.

When micrometer-sized are used, they have an average size measured by the largest particle dimension of about 5 to about 100 μm The nanoparticles can have an average particle size of 5 μm to 90 nm μm 5 μm to 80 μm, 5 μm to 70 μm, 5 μm to 60 μm, 5 μm to 50 μm, 5 μm to 40 μm, 5 μm to 30 μm, 5 μm to 20 μm, 5 μm to 10 μm, or any range or sub-range between these values. The nanoparticles can have an average particle size of about 5 μm, 10 μm, 15 μm, 20 nm μm 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, or any range or sub-range between these values. Particle sizes can be determined by any suitable technique, including laser diffraction, dynamic light scattering, sedimentation, image analysis, and acoustic spectroscopy.

Suitable tea polyphenol and phenolic compounds can include epigallocatechin-3-gallate, epicatechin, epicatechin-3-gallate, epigallocatechin, gallocatechin, theaflavin, theaflavin-3-gallate, and combinations thereof. Table 1 shows the chemical structures of some suitable polyphenols.

TABLE 1
Structures of some tea polyphenols suitable for use in the composition.

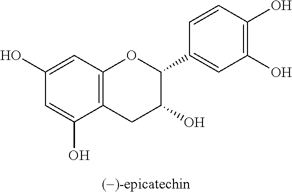 [SMILES: Oc1cc(O)c2c(c1)O[C@H](c1ccc(O)c(O)c1)[C@H](O)C2]

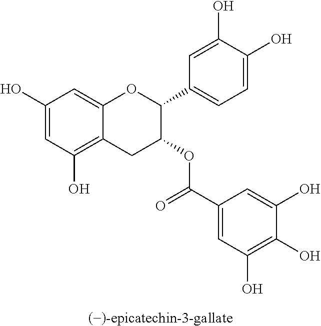 [SMILES: O=C(O[C@@H]1Cc2c(O)cc(O)cc2O[C@@H]1c1ccc(O)c(O)c1)c1cc(O)c(O)c(O)c1]

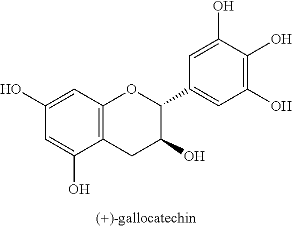 [SMILES: Oc1cc(O)c2c(c1)O[C@H](c1cc(O)c(O)c(O)c1)[C@@H](O)C2]

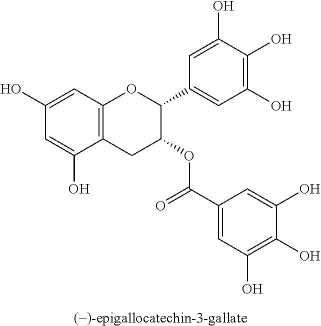 [SMILES: O=C(O[C@@H]1Cc2c(O)cc(O)cc2O[C@@H]1c1cc(O)c(O)c(O)c1)c1cc(O)c(O)c(O)c1]

In various embodiments, the at least one component is about 1 to 30 wt % of the article. The at least one component can be about 1 to 25 wt %, 1 to 20 wt %, 1 to 15 wt %, 1 to 10 wt %, 1 to 9 wt %, 1 to 8 wt %, 1 to 7 wt %, 1 to 6wt %, 1 to 5 wt %, 1 to 4 wt %, 1 to 3 wt %, or 1 to 2 wt % of the article. The at least one component can be about 30 wt %, 25 wt %, 20 wt %, 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt % of the article, or any range or sub-range between any of these values.

The non-woven material can include fibers having an average diameter of 1 to 100 μm. The average diameter corresponds to the largest dimension of the particles. The fibers of the non-woven material can have an average diameter of about 1 to 95 μm, 1 to 90 μm, 1 to 85 μm, 1 to 80 μm, 1 to 75 μm, 1 to 70 μm, 1 to 65 μm, 1 to 60 μm, 1 to 55 μm, 1 to 50 μm, 2 to 50 μm, 3 to 50 μm, 4 to 50 μm, 5 to 50 μm, 1 to 45 μm, 1 to 40 μm, 1 to 35 μm, 1 to 30 μm, 1 to 25 μm, 1 to 20 μm, 1 to 15 μm, 1 to 10 μm, or any range or sub-range between these values. The fibers of the non-woven material can have an average diameter of about 100 μm, 95 μm, 90 μm, 85 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, or any range or sub-range between these values. In various embodiments, the fibers have an average diameter of about 3 to about 30 μm. In various embodiments, the fibers have an average diameter of about 5 to about 20 μm. The average fiber diameter can be determined by any suitable technique, including laser diffraction, interferometry, dynamic light scattering, and image analysis.

The fibers can have a fiber areal weight (FAW) of about 10 to about 300 g/m². The FAW of the fibers can be 10 to 300 g/m², 10 to 275 g/m², 10 to 250 g/m², 10 to 225 g/m², 10 to 200 g/m², 10 to 175 g/m², 10 to 150 g/m², 10 to 140 g/m², 10 to 130 g/m², 10 to 120 g/m², 10 to 110 g/m², 10 to 100 g/m², 10 to 50 g/m², or any range or sub-range between these values. The FAW of the fibers can be 200 g/m², 175 g/m², 150 g/m², 140 g/m², 130 g/m², 120 g/m², 110 g/m², 100 g/m², 90 g/m², 80 g/m², 70 g/m², 60 g/m², 50 g/m², 40 g/m², 30 g/m², 20 g/m², 10 g/m², or any range or sub-range between these values. In various embodiments, the fibers can have a FAW of about 20 to about 150 g/m².

In various embodiments, the article can be at least part of a fabric. The fabric can be made entirely from the non-woven article, or the fabric can include about 5%, 10%, 15%, 20%, 25% 30%, 35%, 40%, 45%, 50%, 55%, 60%, 65%, 70%, 75%, 80%, 85%, 90%, 95%, or 99% by weight of the article. The portion of the fabric that is not the non-woven article can include any suitable woven or non-woven natural fibers such as cotton, wool, silk, and leather. The portion of the fabric that is not the non-woven article can also include synthetic woven fibers, including woven polymers that are suitable for use as the non-woven fibers in the article. The fabric can be manufactured into any suitable object found in a home or office that is made from or includes fabrics, such as, without limitation, a tablecloth, carpet, curtain, wallpaper, upholstery, towel, blanket, bed sheet, bedding bag, or rug.

### Method of Making the Article

In various embodiments, a method of making the article includes spraying a composition comprising the at least one polymer and at least one component reactive with at least one air pollutant onto a surface to form a wet article; and drying the wet article to form the article described herein. The drying can include air drying. The spraying can include blow-spinning. Blow-spinning can include using two parallel concentric fluid streams to deposit a fiber on a surface.

The first fluid stream includes the at least one polymer dissolved or dispersed in a solvent, and the second fluid stream includes a pressurized gas that flows around the polymer solution or dispersion, which creates fibers that are deposited in the direction of gas flow. The pressurized gas can include air or nitrogen and can be generated from a suitable compressed gas source. The polymer solution can be delivered via a suitable pump system such as a syringe pump or peristaltic pump. In various embodiments, the blow-spinning includes extruding the composition via a peristaltic pump.

In various embodiments, the composition further comprises a solvent. The solvent can include formic acid, dimethylformamide, acetonitrile, methanol, ethanol, cyclohexane, ethyl acetate, phenol, dimethyl sulfoxide, dimethylacetamide, toluene, tetrahydrofuran, acetone, and mixtures thereof. In various embodiments, the solvent is dimethylformamide. In various embodiments, substantially all of the solvent evaporates within 1 to 10 minutes after the composition is deposited or sprayed on a desired surface. The composition can be formed by combining the solvent and the at least one polymer to form a mixture; and dispersing the component reactive with the at least one air pollutant in the mixture. In various embodiments, the at least one polymer is dissolved in the solvent.

The at least one polymer is about 1 to 30 wt % of the composition. The at least one polymer can be about 1 to 25 wt %, 1 to 20 wt %, 1 to 15 wt %, 1 to 10 wt %, 1 to 9 wt %, 1 to 8 wt %, 1 to 7 wt %, 1 to 6 wt %, 1 to 5 wt %, 1 to 4 wt %, 1 to 3 wt %, or 1 to 2 wt % of the composition. The at least one polymer can be about 30 wt %, 25 wt %, 20 wt %, 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt % of the composition, or any range or sub-range between any of these values. In various embodiments, the at least one polymer is about 1 to about 10 wt % of the composition.

The component reactive with at least one air pollutant in the mixture can be about 1 to 15 wt % of the composition. The component reactive with at least one air pollutant in the mixture can be about 1 to 10 wt %, 1 to 9 wt %, 1 to 8 wt %, 1 to 7 wt %, 1 to 6 wt %, 1 to 5 wt %, 1 to 4 wt %, 1 to 3 wt %, or 1 to 2 wt % of the composition. The component reactive with at least one air pollutant in the mixture can be about 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt % of the composition, or any range or sub-range between any of these values.

In various embodiments, an article for removing one or more air pollutants from air includes a non-woven material including polyacrylonitrile, and about 1 to 10 wt % of titanium dioxide nanoparticles or microparticles, wherein the non-woven material has a FAW of about 30 to about 100 g/m².

In various embodiments, a method of making the article includes combining dimethylformamide and polyacrylonitrile to form a mixture, dispersing titanium dioxide nanoparticles in the mixture to form a sprayable composition, blow-spinning the sprayable composition to form a wet article; and drying the wet article to form the article for removing air pollutants. The wet article contains residual solvent used to disperse or dissolve the polymer and to disperse the component reactive with the at least one air pollutant.

In various embodiments, a method of removing one or more air pollutants from air includes contacting the article with air. Contacting the article with air can include both allowing air to passively pass over the article as well as actively passing air over the article. Actively passing air over the article can include any suitable method for moving air through or over the article, such as with a fan, blower, or forced air induction.

In various embodiments, a method of using the article includes allowing air to pass to over the article. The article can also be used as a covering for furniture or other items that release VOCs, or the article can form at least a part of an air filter that can be used in suitable residential or commercial settings.

### EXAMPLES

Various embodiments of the present invention can be better understood by reference to the following Examples which are offered by way of illustration. The present invention is not limited to the Examples given herein.

### Example 1. Air Pollutant-Removal Composition and Article

Polyacrylonitrile (70 g, Z111TX-22 supplied by Dow, 7 wt %) was added to dimethylformamide (880 mL, 88 wt %) and mixed well, then titanium dioxide particles (50 g, AEROXIDE P25 supplied by Evonik, 5 wt %, average particle size 21 nm) was uniformly dispersed in the polymer solution. The resulting dispersion was extruded via blow-spinning using a peristaltic pump to form very fine micron non-woven fibers.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Enumerated Embodiments

The following exemplary embodiments are provided, the numbering of which is not to be construed as designating levels of importance:

Embodiment 1 provides an article for removing one or more air pollutants from air, comprising: a non-woven material comprising at least one polymer; and at least one component reactive with at least one air pollutant.

Embodiment 2 provides the article of embodiment 1, wherein the component is homogenously distributed throughout the non-woven material.

Embodiment 3 provides the article of any one of embodiments 1-2, wherein the polymer is chosen from aramid, polyimide, polycaprolactam, polyester, polyvinylchloride, nylon, polyvinylpyrrolidone, poly(methyl methacrylate), polyacrylonitrile, polypropylene, polyethylene, co-polymers thereof, and mixtures thereof.

Embodiment 4 provides the article of any one of embodiments 1-3, wherein the at least one polymer is about 1 to about 20 wt % of the article.

Embodiment 5 provides the article of any one of embodiments 1-4, wherein the air pollutant comprises wherein the volatile organic compound comprises formaldehyde, benzene, toluene, xylene, para-dichlorobenzene, ethyl benzene, styrene, acetaldehyde, cyclohexanone, isophorone, methanol, ethanol, phenol, acetone, ethyl acetate, n-butanol, methyl isobutyl ketone, n-butyl acetate, acetophenone, methyl ethyl ketone, isopropyl alcohol, dichloromethane, trichloroethylene, n-hexane, 2-methoxylethyl acetate, nitrobenzene, bis-(2-methyoxyethyl)ether, 1,3,5-trimethylbenzene, and mixtures thereof.

Embodiment 6 provides the article of any one of embodiments 1-5, wherein the at least one component reacts with an aldehyde or ketone group in the at least one air pollutant.

Embodiment 7 provides the article of any one of embodiments 1-6, wherein the at least one air pollutant is formaldehyde.

Embodiment 8 provides the article of any one of embodiments 1-7, wherein the at least one component is taurine, a tea polyphenol, sodium polyacrylate, chitin, titanium dioxide nanoparticles, titanium dioxide microparticles, a tannin, a lignin, a flavonoid, a phenolic compound, carvacrol, eugenol, and mixtures thereof.

Embodiment 9 provides the article of any one of embodiments 1-8, wherein the at least one component is about 1 to about 30 wt % of the article.

Embodiment 10 provides the article of any one of embodiments 1-9, wherein the non-woven material comprises fibers having an average diameter of about 1 to about100 μm.

Embodiment 11 provides the article of any one of embodiments 1-10, wherein the fibers have an average diameter of about 3 to about 30 μm.

Embodiment 12 provides the article of any one of embodiments 1-11, wherein the fibers have a fiber areal weight (FAW) of about 10 to about 300 g/m².

Embodiment 13 provides the article of any one of embodiments 1-12, wherein the fibers have a FAW of about 20 to about 150 g/m².

Embodiment 14 provides the article of any one of embodiments 1-13, wherein the article comprises at least part of a fabric.

Embodiment 15 provides the article of any one of embodiments 1-14, wherein the fabric comprises a tablecloth, carpet, curtain, wallpaper, upholstery, towel, blanket, bed sheet, bedding bag, or rug.

Embodiment 16 provides a method of making the article of claim 1-15, comprising: spraying a composition comprising at least one polymer and at least one component reactive with at least one air pollutant onto a surface to form a wet article; and drying the wet article to form the article of claim 1.

Embodiment 17 provides the method of embodiment 16, wherein the spraying comprises blow-spinning.

Embodiment 18 provides the method of any one of embodiments 16-17, wherein the composition further comprises a solvent.

Embodiment 19 provides the method of any one of embodiments 16-18, wherein the solvent comprises formic acid, dimethylformamide, acetonitrile, methanol, ethanol, cyclohexane, ethyl acetate, phenoldimethyl sulfoxide, dimethylacetamide, toluene, tetrahydrofuran, acetone, and mixtures thereof.

Embodiment 20 provides the method of any one of embodiments 16-19, wherein the composition is formed by: combining the solvent and the at least one polymer to form a mixture; and dispersing the component reactive with the at least one air pollutant in the mixture.

Embodiment 21 provides the method of any one of embodiments 16-20, wherein the blow-spinning comprises extruding the composition via a peristaltic pump.

Embodiment 22 provides the method of any one of embodiments 16-21, wherein the drying comprises air drying.

Embodiment 23 provides the method of any one of embodiments 16-22, wherein the at least one polymer is about 1 to about 30 wt % of the composition.

Embodiment 24 provides the method of any one of embodiments 16-23, wherein the component reactive with at least one air pollutant in the mixture is about 1 to about 15 wt % of the composition.

Embodiment 25 provides the method of any one of embodiments 16-24, wherein the at least one polymer comprises polyacrylonitrile.

Embodiment 26 provides the method of any one of embodiments 16-25, wherein the solvent is dimethylformamide.

Embodiment 27 provides the method of any one of embodiments 16-26, wherein the component is titanium dioxide nanoparticles.

Embodiment 28 provides an article for removing one or more air pollutants from, comprising: a non-woven material comprising polyacrylonitrile; and about 1 to about 10 wt % of titanium dioxide nanoparticles; wherein the non-woven material has a FAW of about 30 to about 100 g/m².

Embodiment 29 provides a method of making the article of embodiment 28, comprising: combining dimethylformamide and of polyacrylonitrile to form a mixture; dispersing titanium dioxide nanoparticles in the mixture to form a sprayable composition; blow-spinning the sprayable composition to form a wet article; and drying the wet article to form the article of embodiment 27.

Embodiment 30 provides a method of removing one or more air pollutants from air, comprising: contacting the article of embodiments 1-15 with air.

Embodiment 31 provides a method of using the article of embodiments 1-15, comprising: allowing air to pass to over the article of embodiments 1-15.

What is claimed is:

1. An article for removing one or more air pollutants from air, comprising:
a non-woven material comprising at least one polymer; and
at least one component reactive with at least one air pollutant.

2. The article of claim 1, wherein the component is homogeneously distributed throughout the non-woven material.

3. The article of claim 1, wherein the polymer is chosen from aramid, polyimide, polycaprolactam, polyester, polyvinylchloride, nylon, polyvinylpyrrolidone, poly(methyl methacrylate), polyacrylonitrile, polypropylene, polyethylene, co-polymers thereof, and mixtures thereof.

4. The article of claim 1, wherein the at least one polymer is about 1 to about 20 wt % of the article.

5. The article of claim 1, wherein the air pollutant comprises wherein the volatile organic compound comprises formaldehyde, benzene, toluene, xylene, para-dichlorobenzene, ethyl benzene, styrene, acetaldehyde, cyclohexanone, isophorone, methanol, ethanol, phenol, acetone, ethyl acetate, n-butanol, methyl isobutyl ketone, n-butyl acetate, acetophenone, methyl ethyl ketone, isopropyl alcohol, dichloromethane, trichloroethylene, n-hexane, 2-methoxylethyl acetate, nitrobenzene, bis-(2-methyoxyethyl)ether, 1,3,5-trimethylbenzene, and mixtures thereof.

6. The article of claim 1, wherein the at least one component is taurine, a tea polyphenol, sodium polyacrylate, chitin, titanium dioxide nanoparticles, titanium dioxide microparticles, a tannin, a lignin, a flavonoid, a phenolic compound, carvacrol, eugenol, and mixtures thereof.

7. The article of claim 1, wherein the at least one component is about 1 to about 30 wt % of the article.

8. The article of claim 1, wherein the non-woven material comprises fibers having an average diameter of about 1 to about 100 μm.

9. The article of claim 8, wherein the fibers have an average diameter of about 3 to about 30 μm.

10. The article of claim 1, wherein the fibers have a fiber areal weight (FAW) of about 10 to about 300 g/m².

11. A method of making the article of claim 1, comprising:
spraying a composition comprising at least one polymer and at least one component reactive with at least one air pollutant onto a surface to form a wet article; and
drying the wet article to form the article of claim 1.

12. The method of claim 11, wherein the spraying comprises blow-spinning.

13. The method of claim 11, wherein the composition further comprises a solvent.

14. The method of claim 11, wherein the composition is formed by:
combining the solvent and the at least one polymer to form a mixture; and
dispersing the component reactive with the at least one air pollutant in the mixture.

15. The method of claim 14, wherein the at least one polymer is about 1 to about 30 wt % of the composition.

16. The method of claim 14, wherein the component reactive with at least one air pollutant in the mixture is about 1 to about 15 wt % of the composition.

17. An article for removing one or more air pollutants from, comprising:
a non-woven material comprisimg polyacrylonitrile; and
about 1 to 10 wt % of titanium dioxide nanoparticles or microparticles;
wherein the non-woven material has a FAW of about 30 to about 100 g/m².

18. A method of making the article of claim 28, comprising:
combining dimethylformamide and of polyacrylonitrile to form a mixture;
dispersing titanium dioxide nanoparticles in the mixture to form a sprayable composition;
blow-spinning the sprayable composition to form a wet article; and
drying the wet article to form the article of claim 1.

19. A method of removing one or more air pollutants from air, comprising:
contacting the article of claim 1 with air.

20. A method of using the article of claim 1, comprising:
allowing air to pass to over the article of claim 1.
